(19) United States
(12) Patent Application Publication
(10) Pub. No.: US 2012/0302110 A1
(43) Pub. Date: Nov. 29, 2012

(54) CONNECTION ARRANGEMENT FOR THE CONNECTION OF BUS BARS

(75) Inventor: Andreas Altrichter, Waidhofen/Thaya (AT)

(73) Assignee: Eaton Industries (Austria) GmbH, Schrems (AT)

(21) Appl. No.: 13/303,842

(22) Filed: Nov. 23, 2011

Related U.S. Application Data
(60) Provisional application No. 61/416,996, filed on Nov. 24, 2010.

(30) Foreign Application Priority Data
Nov. 24, 2010 (AT) A 1955/2010

(51) Int. Cl. H01R 4/28

(52) U.S. Cl. 439/884

(57) ABSTRACT

A connection arrangement includes a connector for connecting at least two bus bars in an electrically conductive manner. The connector has a first hook-shaped projection which engages in a receptacle of one of the bus bars. The first hook-shaped projection can be constructed to embrace a peripheral area of the receptacle.

### CROSS-REFERENCES TO RELATED APPLICATIONS

This application claims the benefit of prior filed U.S. Provisional Application No. 61/416,996, filed Nov. 24, 2010, pursuant to 35 U.S.C. 119(e).

This application also claims the priority of Austrian Patent Application, Serial No. A 1955/2010, filed Nov. 24, 2011, pursuant to 35 U.S.C. 119(a)-(d).

The contents of U.S. Provisional Application No. 61/416,996 and Austrian Patent Application No. A 1955/2010 are incorporated herein by reference in their entirety as if fully set forth herein.

### BACKGROUND OF THE INVENTION

The present invention relates to bus bar connection arrangements for conductively connecting bus bars.

The following discussion of related art is provided to assist the reader in understanding the advantages of the invention, and is not to be construed as an admission that this related art is prior art to this invention.

Connection arrangements are known for connecting rod-shaped or rail-shaped electric conductors, such as so-called bus bars, with the respective bus bars being bolted to one another. Especially in the case of bus bars connected to each other at a right angle, this type of connection leads to an increased space requirement for the overall conductor arrangement because of the bolts and nuts protruding beyond the bus bars. This leads to an increased space requirement especially in switchboards and distribution systems. Further, the effort for a thorough connection between the two conductors is high because the respective fastening nuts with washers push directly against the bus bars, necessitating a careful and exact spatial orientation of the conductors that have to be connected, to ensure a safe operation.

It would therefore be desirable and advantageous to provide an improved connection arrangement to obviate prior art shortcomings and to permit a space-saving, fast and reliable connection between two bus bars.

### SUMMARY OF THE INVENTION

According to one aspect of the present invention, a connection arrangement includes a connector for connecting at least two bus bars in an electrically conductive manner, the connector having a first hook-shaped projection engaging in a receptacle of one of the bus bars.

As a result, a connection arrangement is realized that requires little space. As a result, building around or over such connection arrangements is simpler than in known connection arrangements. The need for a nut is eliminated and the hook-shaped projection permits a safe assembly in a short time, allowing implementation of a reliable and durable electrically conductive connection.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an axonometric view of a connection arrangement according to the invention between second, third and fourth bus bars;

FIG. 2 shows the connection arrangement according to FIG. 1 further including a first bus bar;

FIG. 3 is a side view of the connection arrangement according to FIG. 2;

FIG. 4 is a further axonometric view of the connection arrangement according to FIG. 2; and

FIG. 5 shows an elevation of the connection arrangement according to FIG. 2, with the first and third bus bars being shown by intersection.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

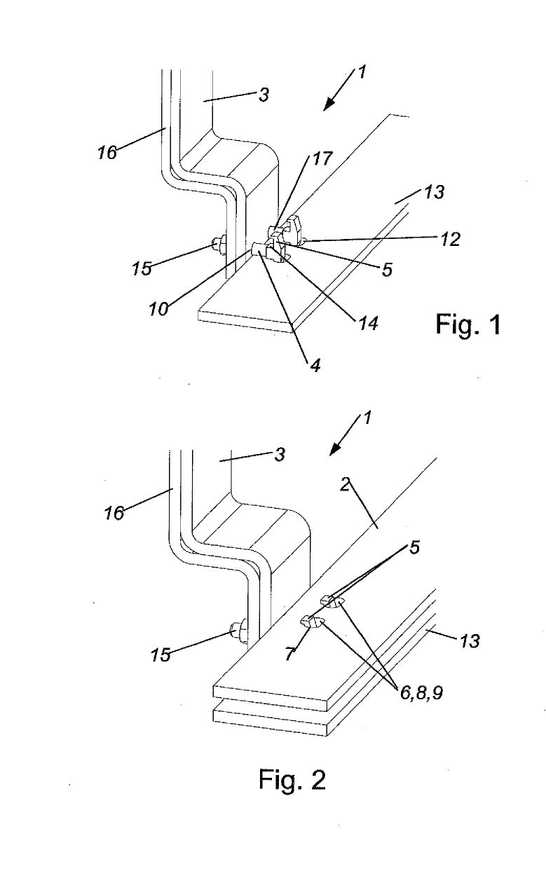

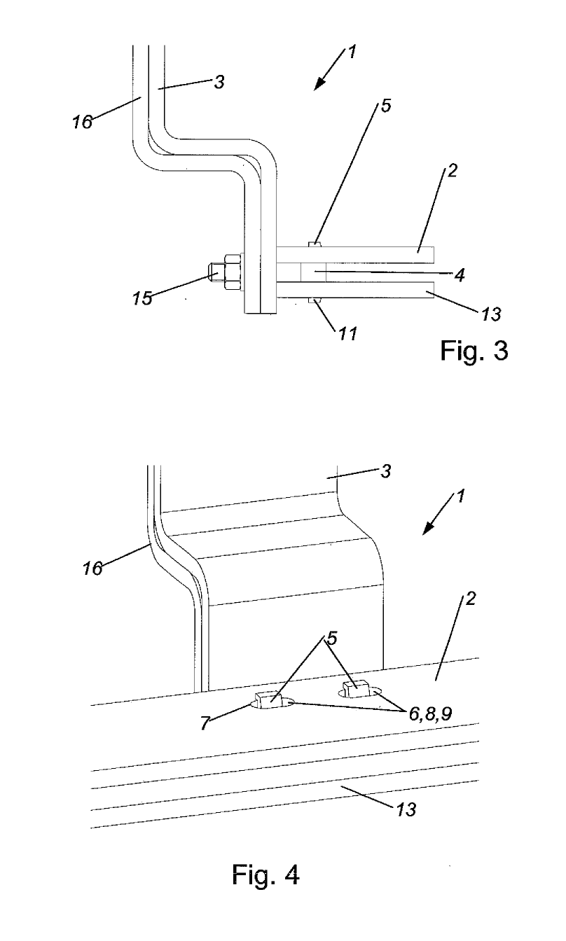

Turning now to the drawing, and in particular to FIGS. 1 to 5, there are shown various preferred embodiments of a connection arrangement 1, wherein at least a first bus bar 2 and a second bus bar 3 are connected in an electrically conducting manner by at least one first connector 4, wherein the first connector 4 has a first hook-shaped projection 5 and wherein the first hook-shaped projection 5 engages into a first receptacle 6 of the first bus bar 2.

As a result, a connection arrangement 1 can be realized which requires little space. As a result, such connection arrangements 1 can be built around or built over in a much more simple way than in known connection arrangements 1. This eliminates the need for a nut and the at least one first hook-shaped projection 5 permits a safe assembly in a short time to allowing realization of a safe and lasting electrically conductive connection.

Connection arrangements 1 according to the invention are provided for the electrically conducting connection of at least two bus bars 2, 3, 13, 16. The term bus bar 2, 3, 13, 16 within the scope of the present invention relates in particular to elongated rod-shaped and/or rail-shaped and/or band-shaped electrical conductors, in particular solid, flat metal bands, preferably comprising copper, silver and/or aluminum. These kinds of bus bars 2, 3, 13, 16 are used in the distribution of electrical energy with significant amperage roughly in the order of several hundred or thousand amperes, for example for producers of electrical energy, industrial plants and/or high powered electrical machines.

Because of the high amperage, it is advantageous in such a connection arrangement 1 to provide a large electrically conductive support or contact surface and a high contact or surface pressure between these kinds of bus bars 2, 3, 13, 16 so as to keep the transfer resistance and therefore the power loss and heating at the site of contact low. The first and second bus bars 2, 3 are therefore connected in an electrically conductive manner by means of a first connector 4. For generating the contact pressure, it has proven advantageous to form the first connector 4, at least in some areas, as a screw. However, it is also possible to rivet the first connectors 4 to at least one of the bus bars 2, 3.

Preferred embodiments of the individual features of a connection arrangement according to the invention 1 will now be described on the basis of a first bus bar 2 and a first connector 4, with the respective preferred embodiments being preferably applicable to possible additional bus bars 3, 13, 16 and/or connectors 17.

According to the invention, the first connector 4 has a first hook-shaped projection 5. Preferably, the first connector 4 has a longitudinal extension, with the first hook-shaped projection 5 being disposed on a first end region of the first connector 4, and a thread 15, particularly an external thread, being disposed on a second end region facing away from the first end region.

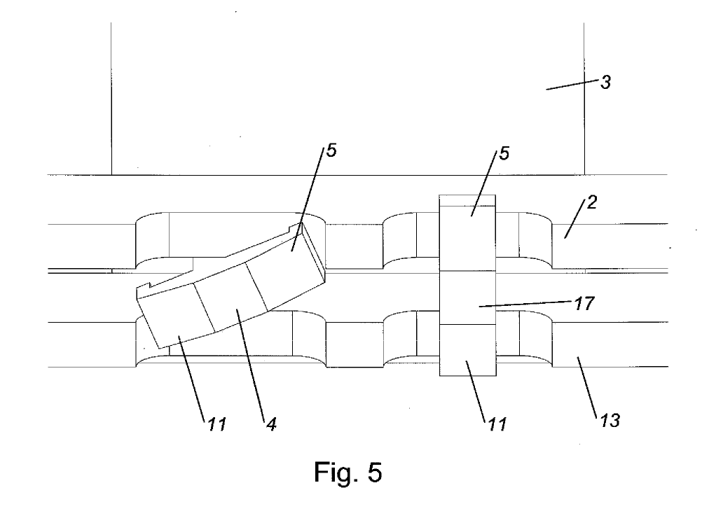

A hook-shaped projection 5 preferably relates to an extension which is angled laterally, in particular substantially at a right angle, from the longitudinal extension, and which has at least one region that extends in the direction of the second end region. According to the preferred embodiments shown in FIGS. 1 to 5, this region is formed essentially as rectangular projection. The thus-shaped projection 5 which is shown particularly well in FIGS. 1 and 5 has therefore the well recognizable shape of a hook.

Alternatively, the respective region can also be formed by at least one, in particular a predefined plurality of saw-tooth-like elevations. Connectors configured in this way have therefore a plurality of hook-shaped projections in side-by-side relationship.

Further, the first bus bar 2 is provided with a first receptacle 6. The first receptacle 6 is provided and configured for engagement of the first hook-shaped projection 5, with the first hook-shaped projection 5 engaging into the first receptacle 6 of the first bus bar 2 in a connection arrangement 1 according to the invention. According to a possible embodiment, the first receptacle 6 can be configured as round blind hole in which areas of the hook-shaped projection 5 engage, with the projection having preferably areas which have a convex outer contour that complements the first receptacle 6.

According to a preferred embodiment, the first hook-shaped projection 5 can embrace or reach behind a peripheral region 7 of the first receptacle 6, in particular in a formfitting manner. This can roughly be achieved by forming the first receptacle 6 with an area having an undercut for engagement of the first hook-shaped projection 5. This ensures a formfitting attachment of the hook-shaped projection 5 to the first bus bar 2.

As an alternative to the preceding exemplary configuration of the first receptacle 6, the first receptacle 6 is configured as first through opening 8 according to the especially preferred embodiment shown FIGS. 1 to 5. Also, this configuration of the first receptacle 6 advantageously permits the presence of an afore-described formfitting attachment which offers advantages particularly with regard to safety against spontaneous opening or loosening of the connection arrangement 1, because a rotation of the first connector 4 relative to the first bus bar 2 is prevented.

It has proven especially advantageous for the hook-shaped projection 5 to traverse the first receptacle 6 which is configured as through opening. This allows in particular for a visual control of the connection arrangement 1. The term traverse relates hereby preferably to the penetration of the first receptacle 6 by a part of the first hook-shaped projection 5.

Preferably, the dimensions of the hook-shaped projection 5 and the bus bars 2, 3 to be connected conform to one another. According to the especially preferred embodiment shown in the Figures, the hook-shaped projection 5 has a receiving region with a clear width, with the clear width corresponding to at least the thickness of the bus bar 2 in a direction which is essentially perpendicular to the longitudinal extension of the first connection element 4. By suiting the dimensions of the first hook-shaped projection 5 to the dimensions of the first bus bar 2, an essentially wobble-free connection arrangement 1 can be created. Preferably, the first bus bar 2 forms a clearance fit together with the clear width of the first hook-shaped projection 5, for example according to the fits H7/g6 or G7/h6.

As shown in the Figures, it is especially preferably provided to configure the first receptacle 6 as oblong hole 9. This has the advantage that, as shown especially in FIG. 5, an arrangement of a first bus bar 2 and a third bus bar 13 in spaced-apart parallel relationship to the first bus bar 2 enables the realization of a connection arrangement 1 according to the invention with small distance by inserting the first connector 4, which has a second hook-shaped projection 11 according to a preferred embodiment for engagement in a third receptacle 12 of a third bus bar 13, in the slot between the two bus bars 2, 13 and subsequently turning it. During insertion, the connector 4 assumes a position relative to the first and third bus bars 2, 13 in which the first and second hook-shaped projections 5, 11 are positioned essentially parallel to the surfaces of the first and third bus bars 2, 13 respectively. Hereby, it is advantageous to arrange the first and second hook-shaped projections 5, 11 symmetrically relative to a longitudinal extension of the first connector 4. In this way, the at least one first connector 4 is pushed to the—respectively opposing-positions of the first and third receptacles 6, 12 which are both formed as oblong holes 9, and turned by 90° in the area of the first and third receptacles 6, 12 so that the first and second hook-shaped projections 5, 11 can be brought into engagement with the receptacles 6, 12, respectively.

Preferably, the first and third receptacles 6, 12 which are each formed as oblong hole 9, are dimensioned to allow a rotation of the first connector 4 in the region of the first receptacle 6 and/or the third receptacle 12.

Especially in combination with the afore-described preferred embodiment, it has proven particularly advantageous to provide the first connector 4 with at least one positioning surface 14 for a predeterminable positioning of the first and/or second hook-shaped projection 5, 11 relative to the first receptacle 6 and to the third receptacle 12, respectively. Such a positioning surface 14, as can be seen for example in FIG. 1, can be formed as a plane surface which is disposed such that the first and/or second hook-shaped projection 5, 11 assumes a preferred position relative to the first and/or third receptacle 6, 12, when the positioning surface bears upon the first and/or third bus bar 2, 13. The provision of at least one positioning surface 14 enables a reliable formation of a connection arrangement 1, even when visibility is limited because the corresponding first connector 4 can also be brought into the intended position as a result of merely haptic sensual impressions.

Preferably, the first connector has adjacent to the hook-shaped projection the cross section of an external square. In this way, two corresponding positioning surfaces 14 can be formed and the distance between the first to the second bus bar 2, 13 can be predefined.

A connection arrangement 1 according to the invention connects at least one first bus bar 2 with a second bus bar 3 by at least one first connector 4. In the especially preferred embodiment shown in FIGS. 1 to 5, first and third bus bars 2, 13 positioned essentially parallel to each other are connected to second and fourth bus bars 3, 16 which are arranged in substantial parallel relationship. The second and fourth bus bars 3, 16 are bent angularly.

In the especially preferred embodiment of a connection arrangement 1 according to the invention shown in FIGS. 1 to 5, the second bus bar 3 is disposed essentially at a right angle relative to the first bus bar 2 in at least the region of the connection arrangement 1. A first top surface of the second bus bar 3 rests against a side surface of the first bus bar 2. In the event—as shown—a third bus bar 13 is further provided, the top surface of the second bus bar 3 rests further upon a side surface of the third bus bar 13. In addition to the shown arrangement of the bus bars 2, 3, 13, 16 with regard to each other, further arrangements can be provided. In particular, arrangements can be provided in which the second bus bar 3 is not disposed at a right angle relative to the first bus bar 2, wherein the side surface of the first bus bar 2 has slanted areas.

For the connection of the first bus bar 2 with the second bus bar 3, it has proven advantageous when the second bus bar 3 has a second receptacle 10 which is formed as through opening 8 for passage of the first connector 4. As an alternative, the second end region can roughly be formed as a clamp which embraces at least some areas of the second bus bar 3.

The first connector 4 is detachably connected to the first and a possible third bus bar 2, 13. As already described, the first connector 2 can be detachably or non-detachably connected to the second or a possible fourth bus bar 3, 16, with non-detachable being understood as not being detachable without destruction. A preferred non-detachable connection includes riveting of the first connector 4 with the second and fourth bus bar 3, 16, respectively.

For the formation of a detachable connection between the second and fourth bus bars 3, 16, respectively, and the first connector 4, the first connector 4 is preferably provided with a thread 15 on an end facing away from the first hook-shaped projection 5 and/or the second hook-shaped projection 11. A nut is placed on the thread in a manner known per se and can be brought into contact on the second or fourth bus bars 3, 16.

In addition to the described embodiments, other embodiments with a different, especially greater number of bus bars 2, 3, 13, 16 and/or connectors 4, 17 can be provided. The figures thus show besides the first connector 4 further a similarly configured second connector 17.

Further embodiments according to the invention have only a part of the described features, wherein any combination of features, especially also of different described embodiments, can be provided.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A connection arrangement, comprising a connector for connecting at least two bus bars in an electrically conductive manner, said connector having a first hook-shaped projection engaging in a receptacle of one of the bus bars.

2. The connection arrangement of claim 1, wherein the first hook-shaped projection embraces a peripheral area of the receptacle.

3. The connection arrangement of claim 2, wherein the first hook-shaped projection embraces the peripheral area of the receptacle in a form fitting manner.

4. The connection arrangement of claim 1, wherein the receptacle is configured as a through opening.

5. The connection arrangement of claim 1, wherein the first hook-shaped projection is sized to traverse the receptacle.

6. The connection arrangement of claim 1, wherein the receptacle is configured as oblong hole.

7. The connection arrangement of claim 1, wherein the connector is constructed for detachable connection to the other one of the bus bars.

8. The connection arrangement of claim 1, wherein the other one of the bus bars has a receptacle configured as through opening for passage of the connector.

9. The connection arrangement of claim 1, wherein the connector has a second hook-shaped projection for engaging a receptacle of a third bus bar.

10. The connection arrangement of claim 9, wherein the first and second hook-shaped projections are arranged symmetrically with regard to a longitudinal extension of the connector.

11. The connection arrangement of claim 9, wherein the connector has at least one positioning surface for a predefined positioning of at least one of the first hook-shaped projection and the second hook-shaped projection in relation to the receptacle of the one of the bus bars or the receptacle of the third bus bar.

12. The connection arrangement of claim 9, wherein the connector has a thread disposed on an end of the connector, which end faces away from at least one of the first hook-shaped projection and the second hook-shaped projection.

13. The connection arrangement of claim 1, wherein the other one of the bus bars is arranged at essentially a right angle relative to the one of the bus bars at least in a region of the connector.
